(19) United States
(12) Patent Application Publication
(10) Pub. No.: US 2007/0253334 A1
(43) Pub. Date: Nov. 1, 2007

(54) SWITCH ROUTING ALGORITHM FOR IMPROVED CONGESTION CONTROL & LOAD BALANCING

(76) Inventors: Chetan Mehta, Austin, TX (US); Nan Ni, Austin, TX (US)

Correspondence Address: IBM CORP (YA);C/O YEE & ASSOCIATES PC, P.O. BOX 802333, DALLAS, TX, 75380, US

(21) Appl. No.: 11/380,271

(22) Filed: Apr. 26, 2006

(51) Int. Cl. H04L 12/26; H04L 12/50

(52) U.S. Cl. 370/237; 370/386

(57) ABSTRACT

A computer implemented method, data processing system, and computer usable program code are provided for routing a packet in a switch system. A set of paths through the switch system to a destination address are determined. The set of paths are analyzed to identify a path with a least used link, where the least used link leads to a next stage of the switch system. The routing to the destination address is set through the path with the least used link to form a selected path in order to improve congestion control and load balancing in response to identifying the path with a least used link.

### BACKGROUND OF THE INVENTION

1. Field of the Invention

The present application relates generally to switch routing. Particularly, the present application relates to providing a switch routing algorithm for improved congestion control and load balancing.

2. Description of the Related Art

In packet switching, messages are divided into segments or packets. These packets may be transmitted over different selected channels in a network. Each packet contains address information as well as other information regarding message treatment. Contention can occur during packet delivery at each switch. Most applications using packet switching do not necessarily operate in real time. Packets may be stored in switch and delayed until the contention is resolved or the switch runs out of storage capacity.

Major functions of switches include signaling and control. Signaling may be over the message channel or a separate signaling network. Control interprets the address of the destination, determines a route for the call or packet, and establishes a path within the switch fabric, as well as participates in the operation, maintenance, and administration of the switch. The selection of a path toward the destination address is the principal function of the switch.

When a switch fabric establishes a desired connection between idle ports, independent of traffic being carried, the switch fabric is said to be non-blocking. Each input of a switch fabric must have at least one path to reach each of the output ports. This situation or condition is known as availability. However, in case of congestion, a desired connection may not be established. In these cases the fabric is said to block. Blocking is a measure of the quality of service rendered. With some services, an alternative to blocking involves delayed transmission. A delay is practical when the input signals are digital. When a service can tolerate time delays, storing of all or part of messages may be introduced in the switch. This buffering is inherently limited in capacity and therefore implies possible loss of message content.

Two-way ports or inputs may have a single appearance on a switch fabric. This type of fabric is called single sided. A more common type of fabric is two sided with ports on each side. Each path has an input and an output. With respect to the flow of traffic, one-sided fabrics are inherently bidirectional whereas two-sided fabrics may be unidirectional or bidirectional.

Routing of packets from a source address to a destination address is important and, thus, selecting the fastest, non-congested, non-blocking path is the primary function of a switch.

### SUMMARY OF THE INVENTION

The different illustrative embodiments provide a computer implemented method, data processing system, and computer usable program code for routing a packet in a switch system. The illustrative embodiments determine a set of paths through the switch system to a destination address. The illustrative embodiments analyze the set of paths to identify a path with a least used link leading to a next stage of the switch system. Responsive to identifying the path with a least used link, the illustrative embodiments set the routing to the destination address through the path with the least used link to form a selected path in order to improve congestion control and load balancing.

### BRIEF DESCRIPTION OF THE DRAWINGS

The novel features believed characteristic of the embodiments are set forth in the appended claims. The illustrative embodiments, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the illustrative embodiments may be implemented;

FIG. 2 depicts a block diagram of a data processing system in which the illustrative embodiments may be implemented;

FIG. 3 depicts a multiple routing situation in accordance with an illustrative embodiment;

FIG. 4 depicts an exemplary pictorial representation of optimal routing of packets through a switch in accordance with an illustrative embodiment;

FIG. 5 depicts a functional block diagram of a routing generator used to implement a switch routing algorithm to improve congestion control and load balancing in accordance with an illustrative embodiment; and

FIG. 6 depicts an exemplary operation of a routing generator that uses a switch routing algorithm to improve congestion control and load balancing in accordance with an illustrative embodiment.

### DETAILED DESCRIPTION OF THE PREFERRED EMBODIMENT

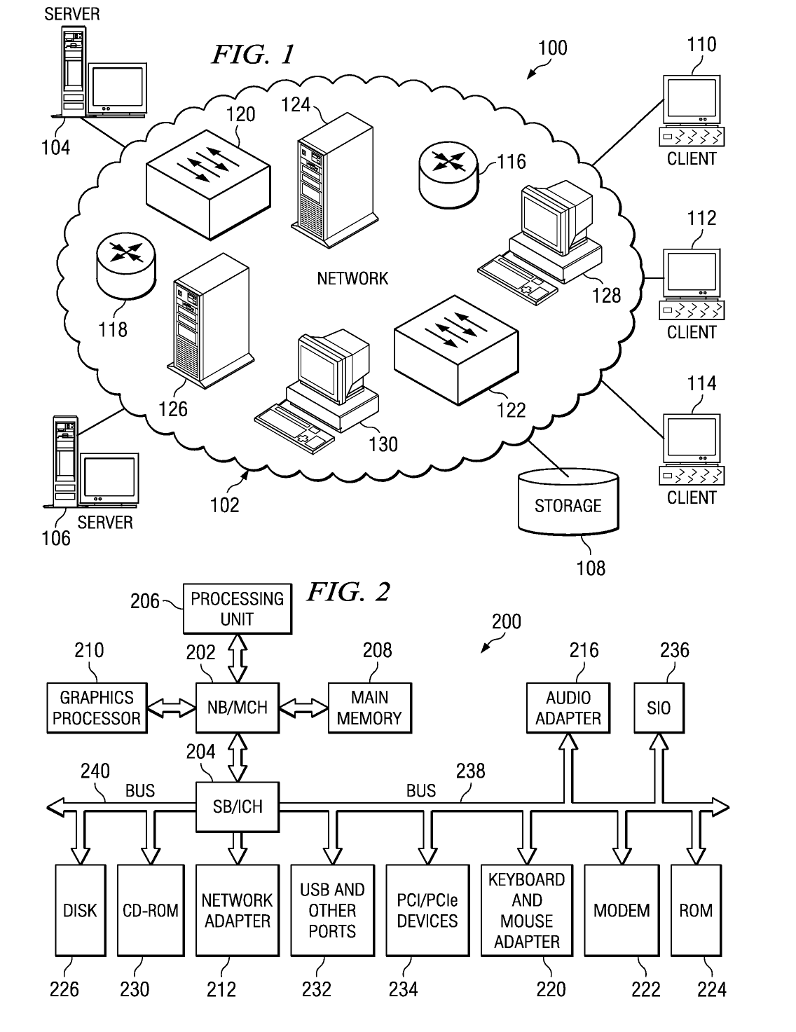

The illustrative embodiments provide a switch routing algorithm for improved congestion control and load balancing. With reference now to the figures and in particular with reference to FIGS. 1-2, exemplary diagrams of data processing environments are provided in which different embodiments may be implemented. It should be appreciated that FIGS. 1-2 are only exemplary and are not intended to assert or imply any limitation with regard to the environments in which embodiments may be implemented. Many modifications to the depicted environments may be made to the different illustrative embodiments.

With reference now to the figures, FIG. 1 depicts a pictorial representation of a network of data processing systems in which the illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables. Network 102 may also include connection devices, such as routers 116 and 118, switches 120 and 122, servers 124 and 126, or clients 128 and 130, all of which, either alone or in any combination, may provide routing of communications through network 102.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as servers 104 or 124, client 110 or 128, router 116, or switch 120 in FIG. 1, in which computer usable code or instructions implementing the processes for embodiments may be located.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the depicted embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus, and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide for a computer implemented method, apparatus, and computer usable program code for compiling source code. The computer implemented methods of the illustrative embodiments may be performed in a data processing system, such as data processing system 100 shown in FIG. 1 or data processing system 200 shown in FIG. 2.

The illustrative embodiments provide a switch routing algorithm for improved congestion control and load balancing. A switch, such as switch 120 or 122 of FIG. 1, may contain switch elements (SE). An incoming packet may pass through a series of switch elements inside a switch. Each switch element is programmed with a routing table indicating where to forward the packet next.

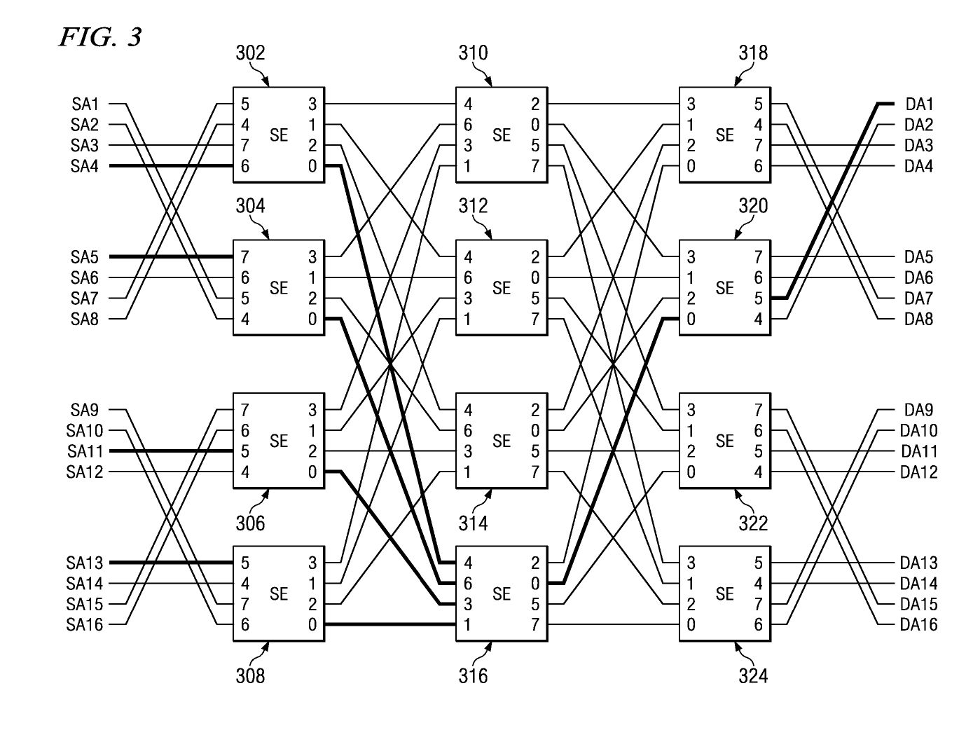

FIG. 3 depicts a multiple routing situation in accordance with an illustrative embodiment. Switch 300 may be a switch, such as switch 120 or 122 of FIG. 1. This illustrative embodiment depicts switch 300 with twelve switch elements 302, 304, 306, 308, 310, 312, 314, 316, 318, 320, 322, and 324, which all are programmed with individual routing tables. As shown, there may be multiple paths to a destination address, thus, the set up of the routing table for a particular switch element inside switch 300 is performed by selecting the route through a switch element port that is least used.

In the case of a tie, an algorithm is set to choose the switch element port with the smallest identification number. For example, when generating a route to DA1, switch element 302 chooses a path (shown bolded) that goes through port 0 because initially none of the ports on switch element 302 are used and port 0 has the smallest port identification in switch element 302. Similarly, switch elements 304, 306, and 308 follow the same approach whereby they choose a path (shown bolded) through port 0 which leads to switch element 316. Thus, using presently known algorithms for building switch element routing tables, a bottleneck may be created at a particular switch element, such as the bottleneck shown at switch element 316.

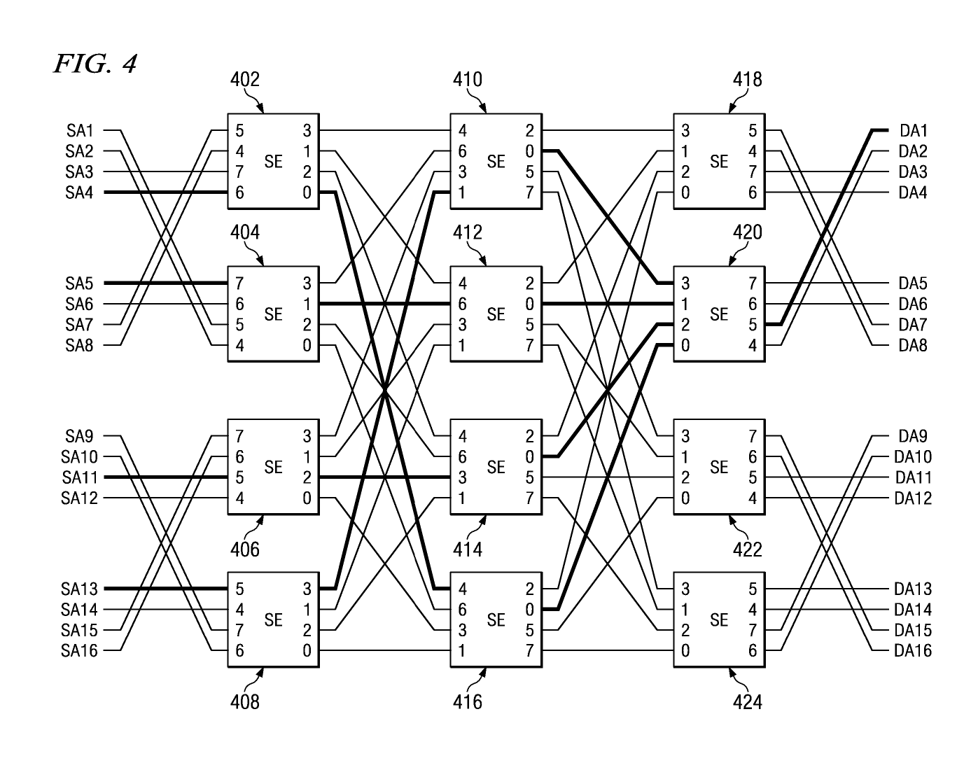

FIG. 4 depicts an exemplary pictorial representation of optimal routing of packets through a switch in accordance with an illustrative embodiment. In these examples, switch 400 may be a hardware switch, a software switch, or a switch which uses a combination of hardware and software. Switch 400 may be a switch, such as switch 120 or 122 of FIG. 1. Within switch 400 there may be any number of switch elements. This illustrative embodiment depicts twelve switch elements 402, 404, 406, 408, 410, 412, 414, 416, 418, 420, 422, and 424, which are all programmed with individual routing tables. When switch 400 receives a packet from source address, it is received by one of switch elements 402, 404, 406, or 408. The receiving switch element checks its routing table to determine which of switch elements 410, 412, 414, or 416, inside switch 400, to forward the packet to next. The next receiving switch element checks its routing table to determine which of switch elements 418, 420, 422, or 424, inside switch 400, to forward the packet to next. When one of switch elements 418, 420, 422, or 424 receive the packet, that receiving switch element delivers the received packet to the destination address.

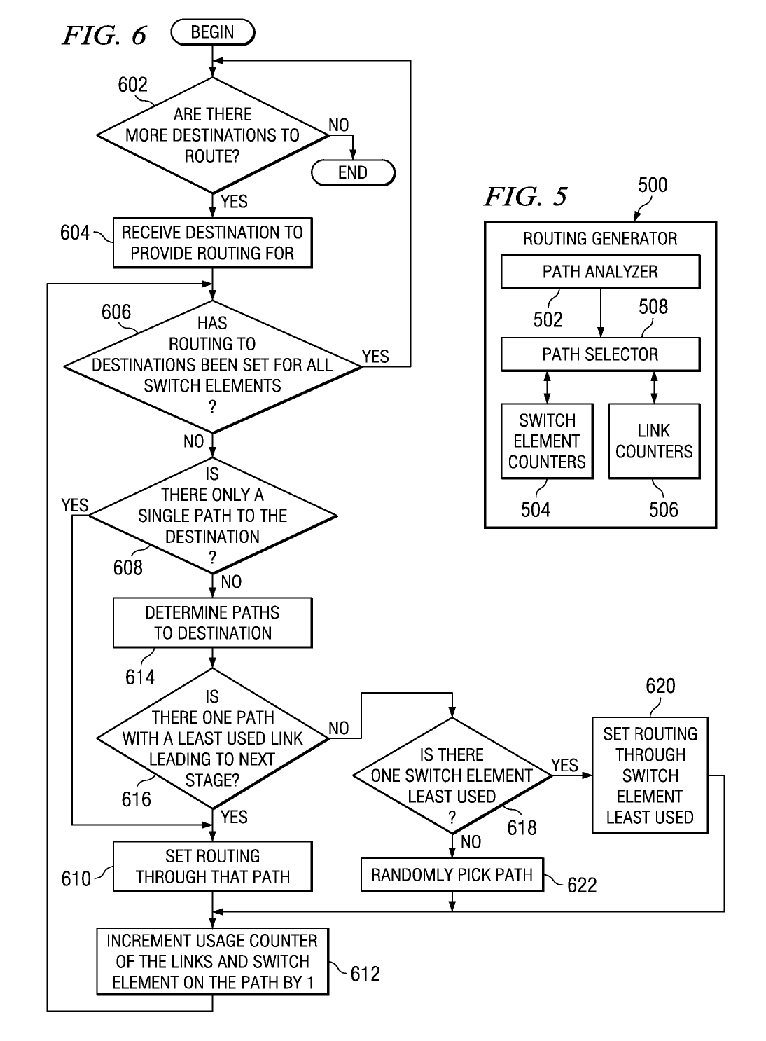

As an illustration of the operation of switch elements 402, 404, 406, or 408: switch element 402 checks its ports in the order of 0, 1, 2, 3; switch element 404 checks its ports in the order of 1, 2, 3, 0; switch element 406 checks its ports in the order of 2, 3, 0, 1; and switch element 408 checks its ports in the order of 3, 0, 1, 2. Thus, to route an incoming packet to DA1, switch element 402 will use port 0, switch element 404 will use port 1, switch element 406 will use port 2, and switch element 408 will use port 3. These ports lead to switch elements 416, 412, 414, and 410, respectively. The routing depicted in this example is purely illustrative, as any switch element may have any routing sequence as long as no two routing sequences exist on multiple switch elements. The illustrative embodiments of FIGS. 5 and 6 provide an example of implementing a switching system that provides optimal routing of packets as shown in FIG. 4.

FIG. 5 depicts a functional block diagram of a routing generator used to implement a switch routing algorithm to improve congestion control and load balancing in accordance with an illustrative embodiment. Routing generator 500 may be a program that is run using a data processing system, such as data processing system 200 of FIG. 2. Routing generator 500 includes path analyzer 502 that is able to generate all of the paths within a switch based on the number of switch elements and links within the switch, such as switch 400 of FIG. 4. Links are the connections between the switch elements. Routing generator 500 also includes a switch counter within switch element counters 504 and link counter within link counters 506 for all of the switch elements and links within the switch. Each time a path is selected by path selector 508, the counter for each switch element and link used in the path is incremented within switch element counters 504 and link counters 506.

FIG. 6 depicts an exemplary operation of a routing generator that uses a switch routing algorithm to improve congestion control and load balancing in accordance with an illustrative embodiment. Instead of switch elements, such as switch elements 402, 404, 406, 408, 410, 412, 414, 416, 418, 420, 422, and 424 of FIG. 4, always choosing the port with the smallest identification number, the exemplary switch routing algorithm checks the ports in a different order for each different switch element.

As the operation begins, a routing generator, such as routing generator 500 of FIG. 5, determines whether there are more destination addresses that need a route generated (step 602). This determination may be made by prompting the user. If there are no more destination addresses to provide routing to, the operation ends.

If at step 602 there are more destination addresses to route to, the routing generator receives a destination address that the switch elements need to route to (step 604). The routing generator then determines if the routing to the destination address has been set for all of the switch elements (step 606). If the routing has been set for all of the switch elements, the operation returns to step 602. If at step 606 the routing has not been set for all of the switch elements, the routing generator determines if there is only a single path to the destination address (step 608). An example of this may be where switch element 420 of FIG. 4 only has one path to destination address DA1.

If there is only one path to the destination address, the routing generator sets the routing through that path (step 610). Then the routing generator increments the link counter and switch element counter for each switch element and link used in the generated path or route (step 612), with the operation returning to step 606 thereafter. If at step 608 there are multiple paths to the destination address, the routing generator determines all of the paths the switch may use to route to the destination address (step 614). The routing generator determines if there is one least used link leading to the next stage of switch elements within the determined paths based on link counter number (step 616). If there is one least used link leading to the next stage of switch elements within the determined paths, the routing generator sets the routing through that path (step 610), with the operation continuing to step 612 thereafter.

If at step 616 there are two or more links leading to the next stage of switch element that are least used within the determined paths, then the routing generator looks at the switch element counters. If one switch element exists that has a lower counter number than any other switch element (step 618), then routing generator selects the path that includes that switch element as the preferred path (step 620), with the operation continuing to step 612 thereafter. If two or more switch elements exist that have the same counter number, then the routing generator randomly picks a path (step 622), with the operation continuing to step 612 thereafter.

Thus, the illustrative embodiments provide for routing a packet in a switch system. A routing generator determines a set of paths through the switch system to a destination address. The routing generator analyzes the set of paths to identify a path with a least used link, where the least used link leads to a next stage of the switch system. Finally, the routing generator sets the routing to the destination address through the path with the least used link to form a selected path in order to improve congestion control and load balancing in response to identifying the path with a least used link.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for routing a packet in a switch system, the computer implemented method comprising:
determining a set of paths through the switch system to a destination address;
analyzing the set of paths to identify a path with a least used link, wherein the least used link leads to a next stage of the switch system; and
responsive to identifying the path with the least used link, setting routing to the destination address through the path with the least used link to form a selected path in order to improve congestion control and load balancing.

2. The computer implemented method of claim 1, further comprising:
responsive to the identification of two or more paths with least used links, analyzing a set of switch elements counters for switch elements in the next stage to identify a switch element that is least used; and
responsive to identifying the least used switch element, setting the routing to the destination address through the least used switch element to form the selected path.

3. The computer implemented method of claim 2, further comprising:
responsive to the identification of two or more least used switch elements, randomly picking one of the two or more paths to form the selected path.

4. The computer implemented method of claim 1, wherein the least used link is identified using a value of a link counter associated with the least used link.

5. The computer implemented method of claim 1, further comprising:
incrementing a switch element counter and a link counter for each of a set of switch elements and each of a set of links used in the selected path.

6. The computer implemented method of claim 1, wherein the selected path includes a set of switch elements and a set of links.

7. The computer implemented method of claim 1, wherein the switch system is at least one of a hardware switch, a software switch, or a switch which uses a combination of hardware and software.

8. A data processing system comprising:
a bus system;
a communications system connected to the bus system;
a memory connected to the bus system, wherein the memory includes a set of instructions; and
a processing unit connected to the bus system, wherein the processing unit executes the set of instructions to determine a set of paths through the switch system to a destination address; analyze the set of paths to identify a path with a least used link, wherein the least used link leads to a next stage of the switch system; and set routing to the destination address through the path with the least used link to form a selected path in order to improve congestion control and load balancing in response to identifying the path with the least used link.

9. The data processing system of claim 8, wherein the processing unit executes the set of instructions to analyze a set of switch elements counters for switch elements in the next stage to identify a switch element that is least used in response to the identification of two or more paths with least used links; and set the routing to the destination address through the least used switch element to form the selected path in response to identifying the least used switch element.

10. The data processing system of claim 9, wherein the processing unit executes the set of instructions to randomly pick one of the two or more paths to form the selected path in response to the identification of two or more least used switch elements.

11. The data processing system of claim 8, wherein the least used link is identified using a value of a link counter associated with the least used link.

12. The data processing system of claim 8, wherein the processing unit executes the set of instructions to increment a switch element counter and a link counter for each of a set of switch elements and each of a set of links used in the selected path.

13. The data processing system of claim 8, wherein the selected path includes a set of switch elements and a set of links.

14. A computer program product comprising:
a computer usable medium including computer usable program code for routing a packet in a switch system, the computer program product including:
computer usable program code for determining a set of paths through the switch system to a destination address;
computer usable program code for analyzing the set of paths to identify a path with a least used link, wherein the least used link leads to a next stage of the switch system; and
computer usable program code for setting routing to the destination address through the path with the least used link to form a selected path in order to improve congestion control and load balancing in response to identifying the path with the least used link.

15. The computer program product of claim 14, further including:
computer usable program code for analyzing a set of switch elements counters for switch elements in the next stage to identify a switch element that is least used in response to the identification of two or more paths with least used links; and
computer usable program code for setting the routing to the destination address through the least used switch element to form the selected path in response to identifying the least used switch element.

16. The computer program product of claim 15, further including:
computer usable program code for randomly picking one of the two or more paths to form the selected path in response to the identification of two or more least used switch elements.

17. The computer program product of claim 14, wherein the least used link is identified using a value of a link counter associated with the least used link.

18. The computer program product of claim 14, further including:
computer usable program code for incrementing a switch element counter and a link counter for each of a set of switch elements and each of a set of links used in the selected path.

19. The computer program product of claim 14, wherein the selected path includes a set of switch elements and a set of links.

20. The computer program product of claim 14, wherein the switch system is at least one of a hardware switch, a software switch, or a switch which uses a combination of hardware and software.
